(19) United States
(12) Patent Application Publication
(10) Pub. No.: US 2025/0036943 A1
(43) Pub. Date: Jan. 30, 2025

(54) METHOD AND APPARATUS WITH NEURAL NETWORK OPERATION OF HOMOMORPHIC ENCRYPTED DATA

(71) Applicants: Samsung Electronics Co., Ltd., Suwon-si (KR); Seoul National University R&DB Foundation, Seoul (KR); Industry-Academic Cooperation Foundation, Chosun University, Gwangju (KR); Chung Ang University Industry Academic Cooperation Foundation, Seoul (KR); POSTECH Research and Business Development Foundation, Pohang-si (KR)

(72) Inventors: Yongjune KIM, Pohang-si (KR); Junghyun LEE, Seoul (KR); Young-Sik KIM, Gwangju (KR); Jong-Seon NO, Seoul (KR); Jiheon WOO, Pohang-si (KR); Eunsang LEE, Seoul (KR); Joon-Woo LEE, Seoul (KR)

(73) Assignees: Samsung Electronics Co., Ltd., Suwon-si (KR); Seoul National University R&DB Foundation, Seoul (KR); Industry-Academic Cooperation Foundation, Chosun University, Gwangju (KR); Chung Ang University Industry Academic Cooperation Foundation, Seoul (KR); POSTECH Research and Business Development Foundation, Pohang-si (KR)

(21) Appl. No.: 18/760,483

(22) Filed: Jul. 1, 2024

(30) Foreign Application Priority Data
Jul. 28, 2023 (KR) 10-2023-0099121
Oct. 31, 2023 (KR) 10-2023-0148473

(51) Int. Cl. G06N 3/08; G06N 3/04; H04L 9/00

(52) U.S. Cl. CPC G06N 3/08; G06N 3/04; H04L 9/008

(57) ABSTRACT

A processor-implemented method includes receiving data for performing a neural network operation of homomorphic encrypted data and a parameter for generating an approximate polynomial corresponding to the neural network operation, obtaining layer information corresponding to each of a plurality of layers configuring a neural network based on the data, determining layer importance corresponding to each of the plurality of layers, based on the parameter and the layer information, generating an approximate polynomial approximating the neural network operation for each of the plurality of layers, based on the layer importance, and generating an operation result by performing the neural network operation based on the approximate polynomial.

### CROSS-REFERENCE TO RELATED APPLICATIONS

This application claims the benefit under 35 USC § 119(a) of Korean Patent Application No. 10-2023-0099121, filed on Jul. 28, 2023, and Korean Patent Application No. 10-2023-0148473, filed on Oct. 31, 2023, in the Korean Intellectual Property Office, the entire disclosures of which are incorporated herein by reference for all purposes.

### BACKGROUND

### 1. Field

The following description relates to a method and apparatus with a neural network operation of homomorphic encrypted data.

### 2. Description of Related Art

Homomorphic encryption is an encryption method that enables arbitrary operations between encrypted data. Utilizing homomorphic encryption enables arbitrary operations on encrypted data without decrypting the encrypted data, and homomorphic encryption is lattice-based and thus, resistant to quantum algorithms and safe.

Although homomorphic encryption is able to perform addition and multiplication, when homomorphic encryption is unable to perform a comparison operation, an activation function may be polynomially approximated and used to perform a neural network operation for fully homomorphic encrypted data. However, among the neural network operations, a high order polynomial may be required to accurately approximate an activation function (e.g., a rectified linear unit) to a polynomial.

When using a low order polynomial to perform a neural network operation using fully homomorphic encrypted data, a layer of a neural network may not be deeply layered, and high performance may not be achieved.

In a neural network operation for fully homomorphic encrypted data, when an activation function that is used, such as a rectified linear unit function, is not used, a pre-trained neural network may not be imported and used and a user may need to newly train a model.

In addition, when a high order polynomial is required to accurately approximate a rectified linear unit to a polynomial, much bootstrapping may be required to implement a fully homomorphic encryption operation in a deep neural network, thereby, excessive time consumption may be required.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes: receiving data for performing a neural network operation of homomorphic encrypted data and a parameter for generating an approximate polynomial corresponding to the neural network operation; obtaining layer information corresponding to each of a plurality of layers configuring a neural network based on the data; determining layer importance corresponding to each of the plurality of layers, based on the parameter and the layer information; generating an approximate polynomial approximating the neural network operation for each of the plurality of layers, based on the layer importance; and generating an operation result by performing the neural network operation based on the approximate polynomial.

The generating of the approximate polynomial may include determining a degree of the approximate polynomial based on the layer importance.

The obtaining of the layer information may include determining a mean and a standard deviation of input data of a layer configuring a neural network based on the data.

The determining of the layer importance may include: determining an error between the neural network operation and the approximate polynomial based on the parameter, the mean, and the standard deviation; and determining a degree of the approximate polynomial based on the error.

The determining of the error may include determining a mean squared error between the neural network operation and the approximate polynomial using a weighted least square.

The receiving of the parameter may include receiving an error threshold corresponding to each of the plurality of layers.

The determining of the degree of the approximate polynomial may include: comparing the error with the error threshold for each of the plurality of layers; and determining the degree of the approximate polynomial corresponding to each of the plurality of layers based on a comparison result.

The determining of the degree of the approximate polynomial may include determining a minimum degree in which the error is less than the error threshold to be the degree of the approximate polynomial.

The determining of the layer importance may include: determining an error between the neural network operation and the approximate polynomial based on the parameter and the layer information; obtaining loss noise determined based on an increment of a loss function occurred by the error; and determining the layer importance based on the loss noise.

The neural network operation may include any one or any combination of any two or more of a rectified linear unit (ReLU), softmax, a leaky ReLU, and a Gaussian error linear unit.

In one or more general aspects, a non-transitory computer-readable storage medium may store instructions that, when executed by one or more processors, configure the one or more processors to perform any one, any combination, or all of operations and/or methods disclosed herein.

In one or more general aspects, an apparatus includes: a receiver configured to receive data for performing a neural network operation of homomorphic encrypted data and a parameter for generating an approximate polynomial corresponding to the neural network operation; and one or more processors configured to: obtain layer information corresponding to each of a plurality of layers configuring a neural network based on the data, determine layer importance corresponding to each of the plurality of layers, based on the parameter and the layer information, generate an approximate polynomial approximating the neural network operation for each of the plurality of layers, based on the layer importance, and generate an operation result by performing the neural network operation based on the approximate polynomial.

For the generating of the approximate polynomial, the one or more processors may be configured to determine a degree of the approximate polynomial based on the layer importance.

For the obtaining of the layer information, the one or more processors may be configured to determine a mean and a standard deviation of input data of a layer configuring a neural network based on the data.

For the determining of the layer importance, the one or more processors may be configured to: determine an error between the neural network operation and the approximate polynomial based on the parameter, the mean, and the standard deviation, and determine a degree of the approximate polynomial based on the error.

For the determining of the error, the one or more processors may be configured to determine a mean squared error between the neural network operation and the approximate polynomial using a weighted least square.

For the receiving of the parameter, the receiver is further configured to receive an error threshold corresponding to each of the plurality of layers.

For the determining of the degree of the approximate polynomial, the one or more processors may be configured to: compare the error with the error threshold for each of the plurality of layers, and determine the degree of the approximate polynomial corresponding to each of the plurality of layers based on a comparison result.

For the determining of the degree of the approximate polynomial, the one or more processors may be configured to determine a minimum degree in which the error is less than the error threshold to be the degree of the approximate polynomial.

For the determining of the layer importance, the one or more processors may be configured to: determine an error between the neural network operation and the approximate polynomial based on the parameter and the layer information, obtain loss noise determined based on an increment of a loss function occurred by the error, and determine the layer importance based on the loss noise.

Other features and aspects will be apparent from the following detailed description, the drawings, and the claims.

### BRIEF DESCRIPTION OF THE DRAWINGS

FIG. 1 illustrates an example of a neural network operation apparatus according to one or more embodiments.

FIG. 2 illustrates an example of a process of a neural network operation apparatus to generate an approximate polynomial according to one or more embodiments.

FIG. 3 illustrates an example of a process of generating an approximate polynomial according to one or more embodiments.

FIG. 4 illustrates an example of a method of determining a degree of an approximate polynomial according to one or more embodiments.

FIG. 5 illustrates an example of a method of calculating a mean squared error function for a rectified linear unit function according to one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms used herein have the same meaning as commonly understood by one of ordinary skill in the art to which this disclosure pertains and specifically in the context on an understanding of the disclosure of the present application. It will be further understood that terms, such as those defined in commonly-used dictionaries, are to be interpreted as having a meaning that is consistent with their meaning in the context of the relevant art and specifically in the context of the disclosure of the present application, and will not be interpreted in an idealized or overly formal sense unless expressly so defined herein.

When describing the embodiments with reference to the accompanying drawings, like reference numerals refer to like constituent elements and a repeated description related thereto will be omitted. In the description of example embodiments, detailed description of well-known related structures or functions will be omitted when it is deemed that such description will cause ambiguous interpretation of the present disclosure.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

The same name may be used to describe an element included in the example embodiments described above and an element having a common function. Unless otherwise mentioned, the descriptions on the example embodiments may be applicable to the following example embodiments and thus, duplicated descriptions will be omitted for conciseness.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

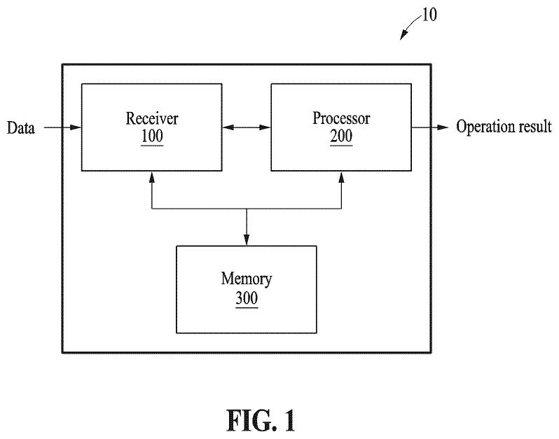

FIG. 1 illustrates an example of a neural network operation apparatus according to one or more embodiments.

Referring to FIG. 1, a neural network operation apparatus 10 may perform a neural network operation. A neural network operation may include an operation used to perform training and/or inference using a neural network.

A neural network operation apparatus 10 may perform a neural network operation of homomorphic encrypted data. Homomorphic encryption may refer to a method of encryption configured to allow various operations to be performed on data as being encrypted. In homomorphic encryption, a result of an operation using ciphertexts may become a new ciphertext, and a plaintext obtained by decrypting the ciphertext may be the same as an operation result of the original data before the encryption.

The neural network may be a model that has the ability to solve a problem, where nodes forming the network through synaptic combinations change a connection strength of synapses through training.

The nodes of the neural network may include a combination of weights or biases. The neural network may include one or more layers each including one or more nodes. The neural network may infer a desired result from a predetermined input by changing the weights of the nodes through training.

The neural network may include a deep neural network (DNN). The neural network may include a convolutional neural network (CNN), a recurrent neural network (RNN), a perceptron, a multilayer perceptron, a feed forward (FF) network, a radial basis network (RBF), a deep feed forward (DFF) network, a long short-term memory (LSTM), a gated recurrent unit (GRU), an auto encoder (AE), a variational auto encoder (VAE), a denoising auto encoder (DAE), a sparse auto encoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a Kohonen network (KN), a binarized neural network (BNN), and/or an attention network (AN).

The neural network operation apparatus 10 may be, or be implemented in, a personal computer (PC), a data server, and/or a portable device.

The portable device may be implemented as a laptop computer, a mobile phone, a smartphone, a tablet PC, a mobile internet device (MID), a personal digital assistant (PDA), an enterprise digital assistant (EDA), a digital still camera, a digital video camera, a portable multimedia player (PMP), a personal navigation device or portable navigation device (PND), a handheld game console, an e-book, and/or a smart device. The smart device may be implemented as a smartwatch, a smart band, and/or a smart ring.

The neural network operation acceleration apparatus 10 may perform a neural network operation using an accelerator. The neural network operation acceleration apparatus 10 may perform a neural network operation using an accelerator. The neural network operation acceleration apparatus 10 may be implemented inside or outside the accelerator.

The accelerator may include a neural processing unit (NPU), a graphics processing unit (GPU), a field-programmable gate array (FPGA), an application-specific integrated circuit (ASIC), and/or an application processor (AP). Alternatively, the accelerator may be implemented as hardware implementing a software computing environment, such as a virtual machine.

The neural network operation apparatus 10 includes a receiver 100 and a processor 200 (e.g., one or more processors). The neural network operation apparatus 10 may further include a memory 300 (e.g., one or more memories).

The receiver 100 may include a receiving interface. The receiver 100 may receive data. The receiver 100 may receive data from an external device or the memory 300. The receiver 100 may output received data to the processor 200.

The receiver 100 may receive data for performing a neural network operation and a parameter for generating an approximate polynomial corresponding to the neural network operation.

The data for performing a neural network operation may include input data input to the neural network and/or a layer configuring the neural network. The parameter for generating an approximate polynomial may include a degree of the approximate polynomial and an error threshold corresponding to each layer. The neural network operation may include a non-linear function operation. For example, the neural network operation may include a rectified linear unit (ReLU), softmax, leaky ReLU, and/or a Gaussian error linear unit (GELU).

The processor 200 may process data stored in the memory 300. The processor 200 may process data stored in the memory 300. The processor 200 may execute computer-readable code (for example, software) stored in the memory 300 and instructions triggered by the processor 200. For example, the memory 300 may include a non-transitory computer-readable storage medium storing instructions that, when executed by the processor 200, configure the processor 200 to perform any one, any combination, or all of operations and methods disclosed herein with reference to FIGS. 1-5.

The processor 200 may be a data processing device implemented by hardware including a circuit having a physical structure to perform desired operations. For example, the desired operations may include code or instructions included in a program.

The hardware-implemented data processing device may include, for example, a microprocessor, a central processing unit (CPU), a processor core, a multi-core processor, a multiprocessor, an application-specific integrated circuit (ASIC), and/or a field-programmable gate array (FPGA).

The processor 200 may obtain (e.g., determined) layer information corresponding to each of a plurality of layers configuring the neural network based on the data, may determine a layer importance corresponding to each of the plurality of layers based on a parameter and the layer information, may generate an approximate polynomial approximating a neural network operation for each of the plurality of layers, and may generate an operation result by performing the neural network operation based on the approximate polynomial.

The processor 200 may determine the degree of the approximate polynomial based on the layer importance.

The processor 200 may calculate (e.g., determine) a mean and a standard deviation of input data of a layer configuring the neural network based on the data.

The processor 200 may calculate an error between the neural network operation and the approximate polynomial based on the parameter, the mean, and the standard deviation, and may determine the degree of the approximate polynomial based on the error. For example, the processor 200 may generate an approximate polynomial approximating a ReLU.

The processor 200 may calculate a mean squared error between the neural network operation and the approximate polynomial using a weighted least square.

The processor 200 may compare the error with the error threshold for each of the plurality of layers and may determine the degree of the approximate polynomial corresponding to each of the plurality of layers based on a comparison result.

The processor 200 may determine a minimum degree in which the error is smaller than the error threshold to be the degree of the approximate polynomial.

The processor 200 may calculate an error between the neural network operation and the approximate polynomial based on the parameter and the layer information, may obtain loss noise determined based on the increment of a loss function that occurred by the error, and may determine layer importance based on the loss noise.

The memory 300 stores instructions (or programs) executable by the processor 200. For example, the instructions may include instructions for performing the operation of the processor 200 and/or an operation of each component of the processor 200.

The memory 300 may be implemented as a volatile or non-volatile memory device.

The volatile memory device may be implemented as dynamic random-access memory (DRAM), static random-access memory (SRAM), thyristor RAM (T-RAM), zero capacitor RAM (Z-RAM), and/or twin transistor RAM (TTRAM).

The non-volatile memory device may be implemented as electrically erasable programmable read-only memory (EEPROM), flash memory, magnetic RAM (MRAM), spin-transfer torque (STT)-MRAM, conductive bridging RAM(CBRAM), ferroelectric RAM (FeRAM), phase change RAM (PRAM), resistive RAM (RRAM), nanotube RRAM, polymer RAM (PoRAM), nano floating gate Memory (NFGM), holographic memory, a molecular electronic memory device, and/or insulator resistance change memory.

The neural network operation apparatus 10 may be installed in a system including a non-arithmetic function among arbitrary operations operated for fully homomorphic encrypted data. The neural network operation apparatus 10 may be installed in all deep learning services including a non-arithmetic function using a Cheon-Kim-Kim-Song (CKKS) scheme among full homomorphic encryptions.

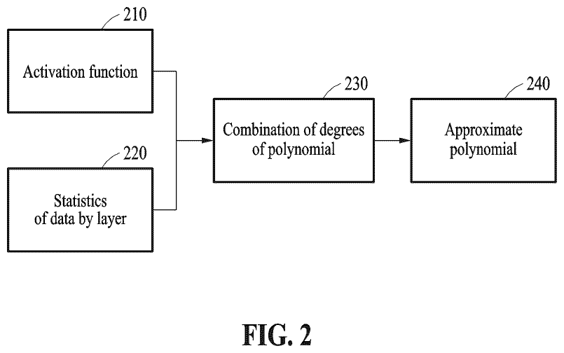

FIG. 2 illustrates an example of a process of a neural network operation apparatus (e.g., the neural network operation apparatus 10 of FIG. 1) to generate an approximate polynomial according to one or more embodiments.

Although typically, in performing deep learning for fully homomorphic encrypted data, a method of accurately approximating a non-arithmetic function (which is unable to compute with addition and multiplication) to a polynomial exists, the method of approximating a polynomial may be used regardless of the accuracy of a deep learning model in which the polynomial is installed.

Typically, a deep learning operation may be performed by approximating a ReLU function of each layer to be used for performing deep learning to polynomials of the same degree.

For example, in a typical method, a polynomial for approximately using an activation function that is used by an actual deep learning model, such as a ReLU function, is configured to perform deep learning for fully homomorphic encrypted data. However, the typical method may be unable to determine a degree of the polynomial considering the accuracy of each layer and the inconvenience of using an unnecessarily great degree may exist.

A processor (e.g., the processor 200 of FIG. 1) according to one or more embodiments may perform a neural network operation of fully homomorphic encrypted data. The processor 200 may approximate a non-linear function (e.g., a ReLU function, softmax, leaky ReLU, and GELU) included in the neural network operation. The processor 200 may effectively approximate a ReLU to a polynomial by considering a distribution of input data for each layer. The ReLU may be expressed by

$$ReLU ( x ) = max \{ x , 0 \} , softmax {( x )}_{i} = \frac{exp ( {x}_{i} )}{Σexp ( {x}_{i} )} , leaky ReLU ( x ) = \{ \begin{matrix}x , x > 0 \\ ax , else\end{matrix} a \approx 0.01 , GELU ( x ) = x Φ ( x ) .$$

When approximating a non-arithmetic function for fully homomorphic encrypted data, the neural network operation apparatus 10 of one or more embodiments may more efficiently adjust depth consumption control by flexibly setting a degree of an approximate polynomial for each layer based on a data value.

For example, the processor 200 may obtain a mean and a standard deviation of input values of a non-arithmetic function of each layer to be approximated and may obtain a mean squared error for each layer by using the distribution of the input values, wherein the mean squared error may occur due to the degree of the polynomial. Thereafter, the processor 200 may determine a predetermined boundary of a mean squared error and may determine a value of a degree of a polynomial that is closest to a value of the boundary for each layer. Through this, the processor 200 of one or more embodiments may flexibly determine the degree of the polynomial of each layer.

Referring to FIG. 2, the neural network operation apparatus 10 may determine a degree 230 of an approximate polynomial for each layer based on an activation function 210 to be approximated and statistics 220 of input data of the activation function 210. For example, a mean y and a standard deviation 6 of the input data may be used as the statistics 220 of the input data.

In the present disclosure, when the degree d of the polynomial is given, a polynomial that minimizes a mean squared error between the activation function 210 ƒ(x) and the polynomial may be generated. The neural network operation apparatus 10 may determine the degree in which a size of a mean squared error in each layer does not exceed a predetermined critical point.

Hereinafter, an activation function applied to an i-th layer may be referred to as ƒᵢ(x), a mean of an input to the activation function ƒᵢ(x) may be referred to as μᵢ, a standard deviation of the input may be referred to as cxi, and a distribution of input values may be referred to as Equation 1 shown below, for example.

$${ϕ}_{i} ( x ) = \frac{1}{\sqrt{2 {πσ}_{i}^{2}}} exp ( - \frac{{( x - {μ}_{i} )}^{2}}{2 {σ}_{i}^{2}} ) \qquad Equation 1 :$$

Hereinafter, when a degree d of a polynomial is given, a polynomial in which a mean squared error is minimized due to approximation of the polynomial in each layer may be referred to as p_{i,d}(x), and a critical point of a mean squared error set by a user may be referred to as E.

The neural network operation apparatus 10 may determine a minimum degree d in which a value of Equation 2 below, for example, which is a mean squared error obtained by approximating an activation function ƒᵢ(x) to the polynomial p_{i,d}(x), is less than E, and the minimum degree may be referred to as dᵢ.

$${\int }_{- ∞}^{∞} {ϕ}_{i} ( x ) {( {f}_{i} ( x ) - {p}_{i , d} ( x ) )}^{2} d x \qquad Equation 2 :$$

The neural network operation apparatus 10 may determine a polynomial degree 230 optimized to data using the statistics 220 of data obtained by inputting the given activation function 210 to each layer, for example, using a mean and a standard deviation. Thereafter, the neural network operation apparatus 10 may determine a combination of an approximate polynomial to be applied to an entire model through a combination of the obtained polynomial degree 230.

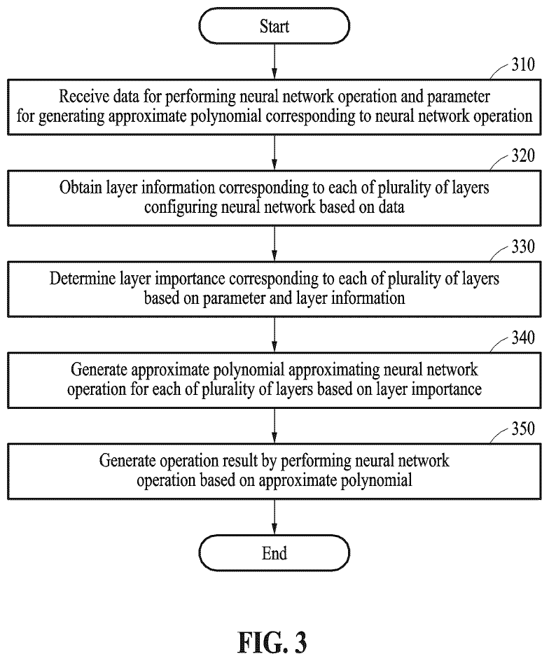

FIG. 3 illustrates an example of a process of generating an approximate polynomial according to one or more embodiments.

For ease of description, it is described that operations 310 to 350 are performed using the neural network operation apparatus 10 of FIG. 1. However, operations 310 to 350 may be performed by another suitable electronic device in any suitable system.

Furthermore, the operations of FIG. 3 may be performed in the shown order and manner. However, the order of one or more of the operations may be changed, one or more of the operations may be omitted, and/or one or more of the operations may be performed in parallel or simultaneously without departing from the spirit and scope of the shown example.

Referring to FIG. 3, in operation 310, the receiver 100 may receive data for performing a neural network operation and a parameter for generating an approximate polynomial corresponding to the neural network operation.

In operation 320, the processor 200 may obtain layer information corresponding to each of a plurality of layers configuring a neural network based on the data.

In operation 330, the processor 200 may determine layer importance corresponding to each of the plurality of layers based on a parameter and the layer information.

In operation 340, the processor 200 may generate an approximate polynomial approximating a neural network operation for each of the plurality of layers based on the layer importance. The processor 200 may determine the degree of the approximate polynomial based on the layer importance.

For example, the neural network operation apparatus 10 of one or more embodiments may maximize the efficiency of an operation by allocating different degrees to respective layers by considering the determined importance of each layer. For example, in an important layer, the neural network operation apparatus 10 of one or more embodiments may extremely minimize an error using a high order polynomial, and in a less important layer, the neural network operation apparatus 10 may allow a predetermined level of error using a low order polynomial, and thereby may increase the operation efficiency.

In one or more embodiments, the neural network operation apparatus 10 may calculate a difference between a non-linear function for each layer and an approximate polynomial approximating the non-linear function, and based thereon, may determine the importance of the layer. For example, as described with reference to FIG. 2, the processor 200 may calculate a mean and a standard deviation of input data of a layer configuring a neural network, may calculate an error between a neural network operation and an approximate polynomial based on the mean and the standard deviation, may compare the error with an error threshold for each of a plurality of layers, and based on a comparison result, may determine a degree of an approximate polynomial corresponding to each of the plurality of layers.

In another embodiment, the neural network operation apparatus 10 may consider an effect of an approximation error in each layer on classification accuracy to quantify the importance of the layer.

For example, a relationship may be determined between two terms to identify a relationship between an approximation error and classification accuracy. When a loss function is minimized in a pre-trained model in plaintext, a loss function value in which an approximation error has occurred may further increase. When the increment is referred to as loss noise, the loss noise may have a negative effect on the classification accuracy, and thus, to minimize the effect, a variance of the loss noise may be used as a surrogate function of the classification accuracy. In addition, in a method of using a surrogate function by considering the importance of a layer, an increment of an output layer occurred through an approximate polynomial may be considered and an increment of a mean squared error may also be considered.

[symbol] ({a_{i,j}}) may denote a loss function, a_{i,j} may denote a j-th node of an i-th layer, Δa_{i,j} may denote an error due to polynomial approximation, and Δ [symbol] := [symbol] ({a_{i,j}+Δa_{i,j}})− [symbol] ({a_{i,j}}) may denote loss noise.

In this case, a variance of the loss noise may be expressed by Equation 3 shown below, for example, through Taylor approximation.

$$Var [ Δ ℒ ] = {{Σ}_{i , j} ( \frac{\partial ℒ}{\partial {a}_{i , j}} )}^{2} Var [ Δ {a}_{i , j} ] = {Σ}_{i} {α}_{i} {E}_{{μ}_{i} , {σ}_{i}^{2}} [ {d}_{i} ; f ] \qquad Equation 3 :$$

In Equation 3, Δa_{i,j} may be an error due to polynomial approximation and may be expressed as a mean squared error.

$${α}_{i} = {{Σ}_{j} ( \frac{\partial ℒ}{\partial {a}_{i , j}} )}^{2}$$

may be a value obtained by quantifying an effect of an i-th layer to classification accuracy. When Aᵢ is a mean of αᵢ for multiple pieces of data, a variance of loss noise may be expressed by Var[Δ [symbol] ]=Σᵢ AᵢE_{μ}_{ᵢ}_{,σ}_{ᵢ}_{²}[dᵢ;ƒ] and an optimization equation in N_{L} layers may be expressed by Equation 4 shown below, for example.

$${min}_{{d}_{1} , … , {d}_{{N}_{L}}} {Σ}_{i = 1}^{{N}_{L}} {A}_{i} E [ {d}_{i} ; f ] subject to {Σ}_{i = 1}^{{N}_{L}} {T}_{i} ( {d}_{i} ) \leq K \qquad Equation 4 :$$

Equation 4 may related to an optimization issue for minimizing loss noise when a sum of degrees is given. In this case, to quantify the given sum of degrees, this may be expressed as time, K may denote an inference time constraint, Tᵢ(dᵢ) may denote a time for polynomial approximation in the i-th layer and bootstrapping.

When an optimal solution is difficult to obtain due to the lack of closed-form expression of

$${T}_{i} ( {d}_{i} ) , {T}_{i}^{Rel , v} ( {d}_{i} ) := \frac{1}{v} .$$

round(Tᵢ(dᵢ)·v) may be defined by discrete relaxation of Tᵢ(dᵢ) and an optimization problem may be generated as Equation 5 shown below, for example.

$${min}_{{d}_{1} , … , {d}_{l}} {Σ}_{i = 1}^{l} {A}_{i} E [ {d}_{i} ; f ] subject to {Σ}_{i = 1}^{l} {T}_{i}^{Rel , v} ( {d}_{i} ) \leq k \qquad Equation 5 :$$

In operation 350, the processor 200 may generate an operation result by performing the neural network operation based on the approximate polynomial.

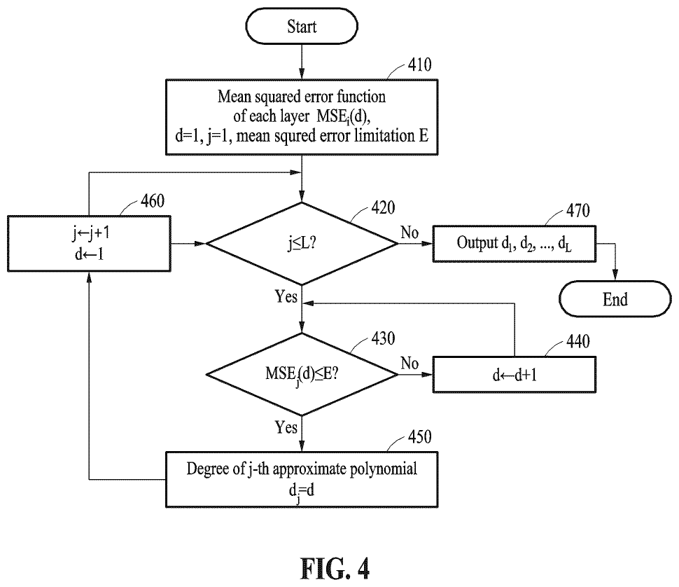

FIG. 4 illustrates an example of a method of determining a degree of an approximate polynomial according to one or more embodiments.

Referring to FIG. 4, when a polynomial p_{i,d}(x) having an arbitrary degree d to be approximated with an activation function ƒᵢ(x) is given, a mean squared error function for the degree may be provided as Equation 2, and a mean squared error limitation E set by a user may be given, the neural network operation apparatus 10 may adjust a degree of a polynomial for each layer.

When L is the number of activation functions in a deep learning model to be approximated, the neural network operation apparatus 10 may obtain a minimum degree dᵢ in which a mean squared error in a j-th layer for all js is less than E. For this, the neural network operation apparatus 10 may increase a d value by 1 and may determine a moment in which a value of MSEⱼ(d) becomes less than E, and may output dⱼ for all layers j by iteratively performing this process on all js.

For example, in operation 410, the processor 200 may obtain a polynomial p_{i,d}(x) having an arbitrary degree d to be approximated with an activation function ƒᵢ(x).

In operation 420, the processor 200 may compare j with Land when j is less than or equal to L, in operation 430, the processor 200 may compare a value of MSEⱼ(d) with E. When the value of MSEⱼ(d) is not less than or equal to (e.g., is greater than) E, in operation 440, the processor 200 may detect d in which the value of MSEⱼ(d) is greater than E by increasing a value of d, and when the value of MSEⱼ(d) is less than or equal to E, in operation 450, the processor 200 may determine the detected d to be a degree dⱼ of a j-th approximate polynomial.

In operation 460, the processor 200 may set d to be “1” again, may increase a value of j, and then may iteratively perform on all js, and in operation 470, may output dⱼ for all layer j.

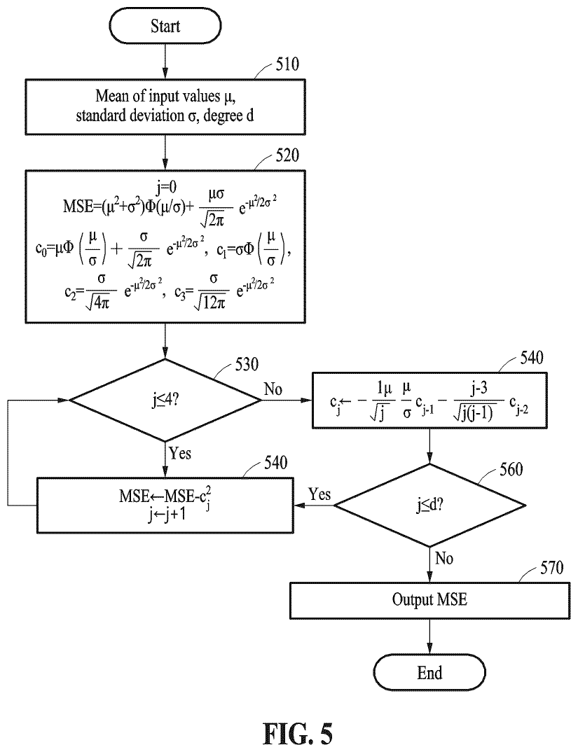

FIG. 5 illustrates an example of a method of calculating a mean squared error function for a rectified linear unit function according to one or more embodiments.

FIG. 5 may be a diagram for describing a method of calculating a value of MSE in the case in which MSE is minimized when a ReLU function is approximated to a d-th polynomial. The ReLU function ReLU(x) used in a neural network may represent max{x, 0}. The processor 200 may approximate a distribution of input values with a weight of

$$ϕ ( x ) = \frac{1}{\sqrt{2 {πσ}^{2}}}$$

exp

$$( - \frac{{( x - μ )}^{2}}{2 {σ}^{2}} ) .$$

In operation 510, the processor 200 may receive a mean, a standard deviation, and a degree of input values.

In operation 520, the processor 200 may set j to be “0” and may calculate MSE, c₀, c₁, c₂, c₃.

In operation 530, the processor 200 may determine whether j is less than or equal to 4. When j is less than or equal to 4, in operation 540, the processor 200 may update MSE−cⱼ² with MSE, may increase a value of j, and may iteratively perform the operation for all js.

When j is not less than or equal to (e.g., is greater than) 4, in operation 550, the processor 200 may update

$$- \frac{1}{\sqrt{j}} \frac{μ}{σ} {c}_{j - 1} - \frac{j - 3}{\sqrt{j ( j - 1 )}} {c}_{j - 2}$$

with cⱼ₋₂, and in operation 560, may compare j with d and when j is less than or equal to d, may proceed to operation 540 and when j is not less than or equal to d, may output a mean squared error in operation 570.

The neural network operation apparatuses, receivers, processors, memories, neural network operation apparatus 10, receiver 100, processor 200, memory 300, described herein, including descriptions with respect to respect to FIGS. 1-5, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-5 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
receiving data for performing a neural network operation of homomorphic encrypted data and a parameter for generating an approximate polynomial corresponding to the neural network operation;
obtaining layer information corresponding to each of a plurality of layers configuring a neural network based on the data;
determining layer importance corresponding to each of the plurality of layers, based on the parameter and the layer information;
generating an approximate polynomial approximating the neural network operation for each of the plurality of layers, based on the layer importance; and
generating an operation result by performing the neural network operation based on the approximate polynomial.

2. The method of claim 1, wherein the generating of the approximate polynomial comprises determining a degree of the approximate polynomial based on the layer importance.

3. The method of claim 1, wherein the obtaining of the layer information comprises determining a mean and a standard deviation of input data of a layer configuring a neural network based on the data.

4. The method of claim 2, wherein the determining of the layer importance comprises:
determining an error between the neural network operation and the approximate polynomial based on the parameter, the mean, and the standard deviation; and
determining a degree of the approximate polynomial based on the error.

5. The method of claim 4, wherein the determining of the error comprises determining a mean squared error between the neural network operation and the approximate polynomial using a weighted least square.

6. The method of claim 4, wherein the receiving of the parameter comprises receiving an error threshold corresponding to each of the plurality of layers.

7. The method of claim 6, wherein the determining of the degree of the approximate polynomial comprises:
comparing the error with the error threshold for each of the plurality of layers; and
determining the degree of the approximate polynomial corresponding to each of the plurality of layers based on a comparison result.

8. The method of claim 7, wherein the determining of the degree of the approximate polynomial comprises determining a minimum degree in which the error is less than the error threshold to be the degree of the approximate polynomial.

9. The method of claim 1, wherein the determining of the layer importance comprises:
determining an error between the neural network operation and the approximate polynomial based on the parameter and the layer information;
obtaining loss noise determined based on an increment of a loss function occurred by the error; and
determining the layer importance based on the loss noise.

10. The method of claim 1, wherein the neural network operation comprises any one or any combination of any two or more of a rectified linear unit (ReLU), softmax, a leaky ReLU, and a Gaussian error linear unit.

11. A non-transitory computer-readable storage medium storing instructions that, when executed by one or more processors, configure the one or more processors to perform the method of claim 1.

12. An apparatus comprising:
a receiver configured to receive data for performing a neural network operation of homomorphic encrypted data and a parameter for generating an approximate polynomial corresponding to the neural network operation; and
one or more processors configured to:
obtain layer information corresponding to each of a plurality of layers configuring a neural network based on the data,
determine layer importance corresponding to each of the plurality of layers, based on the parameter and the layer information,
generate an approximate polynomial approximating the neural network operation for each of the plurality of layers, based on the layer importance, and
generate an operation result by performing the neural network operation based on the approximate polynomial.

13. The apparatus of claim 12, wherein, for the generating of the approximate polynomial, the one or more processors are further configured to determine a degree of the approximate polynomial based on the layer importance.

14. The apparatus of claim 12, wherein, for the obtaining of the layer information, the one or more processors are further configured to determine a mean and a standard deviation of input data of a layer configuring a neural network based on the data.

15. The apparatus of claim 13, wherein, for the determining of the layer importance, the one or more processors are further configured to:
determine an error between the neural network operation and the approximate polynomial based on the parameter, the mean, and the standard deviation, and
determine a degree of the approximate polynomial based on the error.

16. The apparatus of claim 15, wherein, for the determining of the error, the one or more processors are further configured to determine a mean squared error between the neural network operation and the approximate polynomial using a weighted least square.

17. The apparatus of claim 15, wherein, for the receiving of the parameter, the receiver is further configured to receive an error threshold corresponding to each of the plurality of layers.

18. The apparatus of claim 17, wherein, for the determining of the degree of the approximate polynomial, the one or more processors are further configured to:
compare the error with the error threshold for each of the plurality of layers, and
determine the degree of the approximate polynomial corresponding to each of the plurality of layers based on a comparison result.

19. The apparatus of claim 18, wherein, for the determining of the degree of the approximate polynomial, the one or more processors are further configured to determine a minimum degree in which the error is less than the error threshold to be the degree of the approximate polynomial.

20. The apparatus of claim 18, wherein, for the determining of the layer importance, the one or more processors are further configured to:
determine an error between the neural network operation and the approximate polynomial based on the parameter and the layer information,
obtain loss noise determined based on an increment of a loss function occurred by the error, and
determine the layer importance based on the loss noise.
